(19) United States
(12) Patent Application Publication
(10) Pub. No.: US 2014/0156976 A1
(43) Pub. Date: Jun. 5, 2014

(54) METHOD, APPARATUS AND SYSTEM FOR SELECTIVE EXECUTION OF A COMMIT INSTRUCTION

(71) Applicants: Enric Gibert Codina, Barcelona (ES); Josep M. Codina, Hospitalet de Llobregat (ES); Fernando Latorre, Barcelona (ES); Pedro Marcuello, Barcelona (ES); Pedro Lopez, Molins de Rei (ES); Crispin Gomez Requena, Barcelona (ES); Antonio Gonzalez, Barcelona (ES); Mirem Hyuseinova, Barcelona (ES); Christos E. Kotselidis, Linz (AT); Marc Lupon, Barcelona (ES); Carlos Madriles Gimeno, Barcelona (ES); Grigorios Magklis, Barcelona (ES); Alejandro Martinez Vicente, Barcelona (ES); Raul Martinez, Barcelona (ES); Daniel Ortega, Barcelona (ES); Demos Pavlou, Barcelona (ES); Kyriakos A. Stavrou, Barcelona (ES); Georgios Tournavitis, Barcelona (ES); Polychronis Xekalakis, Barcelona (ES)

(72) Inventors: Enric Gibert Codina, Barcelona (ES); Josep M. Codina, Hospitalet de Llobregat (ES); Fernando Latorre, Barcelona (ES); Pedro Marcuello, Barcelona (ES); Pedro Lopez, Molins de Rei (ES); Crispin Gomez Requena, Barcelona (ES); Antonio Gonzalez, Barcelona (ES); Mirem Hyuseinova, Barcelona (ES); Christos E. Kotselidis, Linz (AT); Marc Lupon, Barcelona (ES); Carlos Madriles Gimeno, Barcelona (ES); Grigorios Magklis, Barcelona (ES); Alejandro Martinez Vicente, Barcelona (ES); Raul Martinez, Barcelona (ES); Daniel Ortega, Barcelona (ES); Demos Pavlou, Barcelona (ES); Kyriakos A. Stavrou, Barcelona (ES); Georgios Tournavitis, Barcelona (ES); Polychronis Xekalakis, Barcelona (ES)

(21) Appl. No.: 13/995,441

(22) PCT Filed: Dec. 22, 2011
(86) PCT No.: PCT/US11/67021

§ 371 Date: Jun. 18, 2013

(51) Int. Cl. G06F 9/30

(52) U.S. Cl. CPC G06F 9/30145
USPC 712/228

(57) ABSTRACT

Techniques and mechanisms for a processor to determine whether a commit action is to be performed. In an embodiment, a processor performs operations to determine whether a commit instruction is for contingent performance of a commit action. In another embodiment, one or more conditions of processor state are evaluated in response to determining that the commit instruction is for contingent performance of the commit action, where the evaluation is performed to determine whether the commit action indicated by the commit instruction is to be performed.

### BACKGROUND OF THE INVENTION

1. Field of the Invention

Various embodiments relate generally to operation of a data processor device. More particularly, certain embodiments pertain to mechanisms for determining whether a processor is to perform a commit action indicated by a commit instruction.

2. Background Art

Modern processor designs implement sophisticated checkpointing mechanisms—e.g. register checkpointing and memory checkpointing—which allow optimizer logic to create aggressive optimized versions of code to be executed speculatively. In cases where speculative execution turns out to be correct, speculative states are promoted, through commit actions, to be committed architectural state. On the other hand, incorrect speculative execution leads to processor state being rolled back to a previous, consistent state.

Due to the resources load and store operations require, commit instructions, and the commit actions they invoke, place significant overhead on processor performance, particularly in a multi-core environment. For example, in order to guarantee memory coherency, a commit point requires that all pending memory operations are globally observed in a multi-processor's cache system. As a result, a commit cannot be considered complete until all pending memory misses are observed by the uncore. Due to such requirements, commit actions typically generate around 5%-10% of stall cycles in an in-order processor design.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating certain elements of a computer platform for communicating a commit instruction according to an embodiment.

FIG. 2 is a block diagram illustrating certain elements of a processor for determining whether to perform a commit action indicated by a commit instruction according to an embodiment.

FIG. 3 is a flow diagram illustrating certain elements of a method for processing a commit instruction according to an embodiment.

FIG. 4 is a block diagram illustrating certain elements of a commit instruction according to an embodiment.

FIG. 5 is a logic diagram illustrating certain elements of a circuit for processing a conditional commit instruction according to an embodiment.

### DETAILED DESCRIPTION

Commit instructions or actions can be categorized as commit instruction that require the execution of a commit action for correct functionality (e.g. otherwise, the system does not work) and commit instructions that are executed, for example, merely because optimizer logic has a limited scope of optimization. This latter group of commit instructions or actions may be skipped without affecting correctness, but may impact performance and power (for the good or for the bad). For example, in a software optimizer system consisting of several compilation stages, where the first stage consists of an interpreter or emulator that interprets one instruction at a time and commits the state after each one, such commits are required for correctness. On the other hand, when executing versions of code optimized at other compilation stages, some of the added commit instructions may only be added due to the limited scope of the optimizer logic and may be skipped without affecting correctness.

Embodiments discussed herein variously provide techniques and mechanisms for determining whether a commit action is to be performed by a processor. As used herein, “commit action” refers to a set of one or more operations performed (or to be performed) by a processor to promote to the level of valid processor state some previously merely speculative state which, before the commit action, had been subject to the possibility of being disposed of in some rollback operation.

As used herein, a “commit instruction” (or “commit message”) refers to a communication for indicating to a processor the possibility that a commit action is to be performed. In an embodiment, a commit instruction may indicate that a commit action must be performed—e.g. at least insofar as a sending of the commit instruction is intended to command the performance of a commit action regardless of any other processor state. For brevity, such a command is referred to herein as a categorical command. Alternatively, a commit instruction may indicate a merely contingent performance of a commit action—e.g. at least insofar as a sending of the commit instruction is intended to command a processor to further evaluate one or more conditions of processor state as a basis for determining whether the indicated commit action is to be performed. For brevity, such a command is referred to herein as a conditional command.

A processor may perform an evaluation of a commit instruction to determine whether the commit instruction is for contingent performance of a commit action—e.g. whether the commit instruction represents a contingent command, as distinguished from a categorical commit command. Determining that a commit instruction represents a categorical commit command may include determining that the represented command is not conditional. Similarly, determining that the commit instruction represents a conditional commit command may include determining that the represented commit command is not categorical.

Determining that a commit command is categorical may, for example, be a sufficient condition for a processor to begin a corresponding commit action. By contrast, determining that a commit command is conditional may, for example, cause a processor to initiate an evaluation of one or more additional conditions to determine whether a corresponding commit action is to be performed. Such an evaluation may be performed, for example, to identify that the commit action is to be performed and/or to identify that the commit action is not to be performed. For brevity, one or more operations to determine a categorical nature, or to determine a conditional nature, of a commit command represented by a commit instruction are referred to herein as a “contingency test.”

As used herein, “hint information” refers to information which is tested for and/or otherwise evaluated by a contingency test—insofar as such information may serve as a hint as to whether a commit action will result from the processing of a commit instruction. By way of illustration and not limitation, a contingency test may determine one or more values of certain hint information and/or merely test for the presence (or absence) of certain hint information.

In an embodiment, hint information may be provided in the commit instruction itself. By way of illustration and not limitation, a commit instruction may comprise a field, referred to herein as a command field, for storing information to express that the instruction is of a commit instruction type. The commit instruction type may, for example, be an instruction type which is included in, or otherwise supported by, an instruction set of a processor which is to process the commit instruction.

In an embodiment, information in a command field of a given instruction may express a generic commit instruction type—e.g. where additional information outside of the command field may need to be referred to for resolving whether that particular command instruction is for a contingent commit command or a categorical commit command. In an alternate embodiment, information in a command field of a given instruction may specifically express one of multiple different commit instruction types—e.g. one of a categorical commit instruction type and a contingent commit instruction type—where an instruction set of the processor distinguished between the different commit instruction types.

In an embodiment, a contingency test may be additionally or alternatively based on a presence of hint information and/or an absence of hint information in a commit instruction—e.g. information other than command field information. By way of illustration and not limitation, a commit instruction may include one or more parameters—e.g. including a parameter stored in a bit, flag or other such field—each to store a respective value specifying or otherwise indicating whether the represented commit command is contingent or categorical. A contingency test may evaluate a value stored in such a field or, in an embodiment, merely test for the presence or absence of such a field.

Additionally or alternatively, hint information may be made available to the processor independent of the commit instruction—e.g. where some separate communication has configured a processor to identify the commit instruction as representing either a contingent commit or a categorical commit.

By way of illustration and not limitation, a processor may store or otherwise have access to configuration information which specifies whether commit instructions are presumed, in the absence of an indication to the contrary, to be either contingent or categorical. In an embodiment, such configuration information may be referenced to determine whether a contingency test is to be performed, or whether a commit action is necessarily to be initiated.

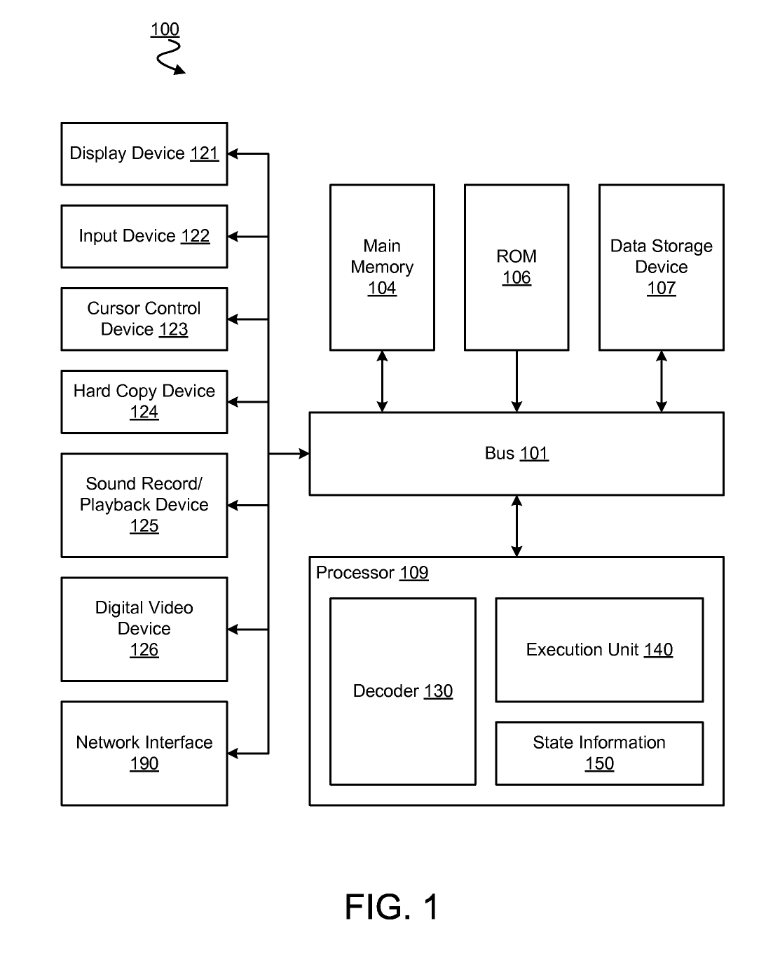

FIG. 1 shows elements of an illustrative computer platform 100 for determining, according to an embodiment, whether to perform a commit action. Computer platform 100 may, for example, include a hardware platform of a personal computer such as a desktop computer, laptop computer, a handheld computer—e.g. a tablet, palmtop, cell phone, media player, and/or the like—and/or other such computer system. Alternatively or in addition, computer platform 100 may provide for operation as a server, workstation, or other such computer system.

In an embodiment, computer platform 100 includes a bus 101 or other such hardware for communicating information and a processor 109—e.g. a central processing unit—for processing such information. Processor 109 may include functionality of a complex instruction set computer (CISC) type architecture, a reduced instruction set computer (RISC) type architecture and/or any of a variety of processor architecture types—e.g. where processor 109 is coupled with one or more other components of computer platform 100 via bus 101. By way of illustration and not limitation, computer platform 100 may include a random access memory (RAM) or other dynamic storage device, represented by an illustrative main memory 104 coupled to bus 101, to store information and/or instructions to be executed by processor 109. Main memory 104 also may be used for storing temporary variables or other intermediate information during execution of instructions by processor 109. Computer platform 100 may additionally or alternatively include a read only memory (ROM) 106 and/or other static storage device—e.g. where ROM 106 is coupled to processor 109 via bus 101—to store static information and/or instructions for processor 109.

In an embodiment, computer platform 100 additionally or alternatively includes a data storage device 107 (e.g., a magnetic disk, optical disk, and/or other machine readable media) coupled to processor 109—e.g. via bus 101. Data storage device 107 may, for example, include instructions or other information to be operated on and/or otherwise accessed by processor 109. In an embodiment, processor 109 may determine whether to perform a commit action, the determining based on a commit instruction and/or other information received from main memory 104, ROM 106, data storage device 107 or any other suitable data source.

Computer platform 100 may additionally or alternatively include a display device 121 for displaying information to a computer user. Display device 121 may, for example, include a frame buffer, a specialized graphics rendering device, a cathode ray tube (CRT), a flat panel display and/or the like. Additionally or alternatively, computer platform 100 may include an input device 122 including alphanumeric and/or other keys to receive user input. Additionally or alternatively, computer platform 100 may include a cursor control device 123, such as a mouse, a trackball, a pen, a touch screen, or cursor direction keys to communicate position, selection or other cursor information to processor 109, and/or to control cursor movement—e.g. on display device 121. Computer platform 100 may additionally or alternatively include a hard copy device 124 such as a printer, a sound record/playback device 125 such as a microphone or speaker, a digital video device 126 such as a still or motion camera and/or the like.

In an embodiment, computer platform 100 includes or couples to a network interface 190 for connecting computer platform 100 to one or more networks (not shown)—e.g. including a dedicated storage area network (SAN), a local area network (LAN), a wide area network (WAN), a virtual LAN (VLAN), an Internet and/or the like. By way of illustration and not limitation, network interface 190 may include one or more of a network interface card (NIC), an antenna such as a dipole antenna, or a wireless transceiver, although the scope of the present invention is not limited in this respect.

Processor 109 may support instructions similar to those in any of a variety of conventional instruction sets—e.g. an instruction set which is compatible with the x86 instruction set used by existing processors. By way of illustration and not limitation, processor 109 may support operations corresponding to some or all operations supported in the IA™ Intel Architecture, as defined by Intel Corporation of Santa Clara, Calif. (see “IA-32 Intel® Architecture Software Developers Manual Volume 2: Instruction Set Reference,” Order Number 245471, available from Intel of Santa Clara, Calif. on the world wide web at developer.intel.com). As a result, processor 109 may support one or more operations corresponding, for example, to existing x86 operations, in addition to the operations of certain embodiments.

Processor 109 may further include circuit logic for processing a commit instruction according to an embodiment. By way of illustration and not limitation, processor 109 may include a decoder 130 to detect a commit instruction which processor 109 has received or otherwise accessed. Commit decoder 130 may decode the detected commit instruction—e.g. according to an instruction set (not shown) of processor 109. Processor 109 may further include an execution unit 140 to execute the decoded commit instruction.

In an embodiment, processing of the commit instruction by decoder 130 and execution unit 140 may include determining whether the commit instruction is for contingent performance of a commit action—i.e. whether the commit instruction represents a contingent commit command. Processor 109 may further include or otherwise have access to state information 150 representing one or more conditions which, for example, are to be evaluated in response to some determination that the commit instruction is for contingent performance of the commit instruction. Evaluation of the one or more conditions in state information 150 may result in the commit action indicated by the commit instruction being performed. Alternatively, evaluation of the one or more conditions of state information 150 may result in the indicated commit action being avoided altogether.

The architecture of computer platform 100 is illustrative of one computer system for processing a commit instruction according to an embodiment. However, the architecture of computer platform 100—e.g. the particular number and types of devices coupled to exchange communications with processor 109 and/or the relative configuration of such devices with respect to one another—may not be limiting on certain embodiments.

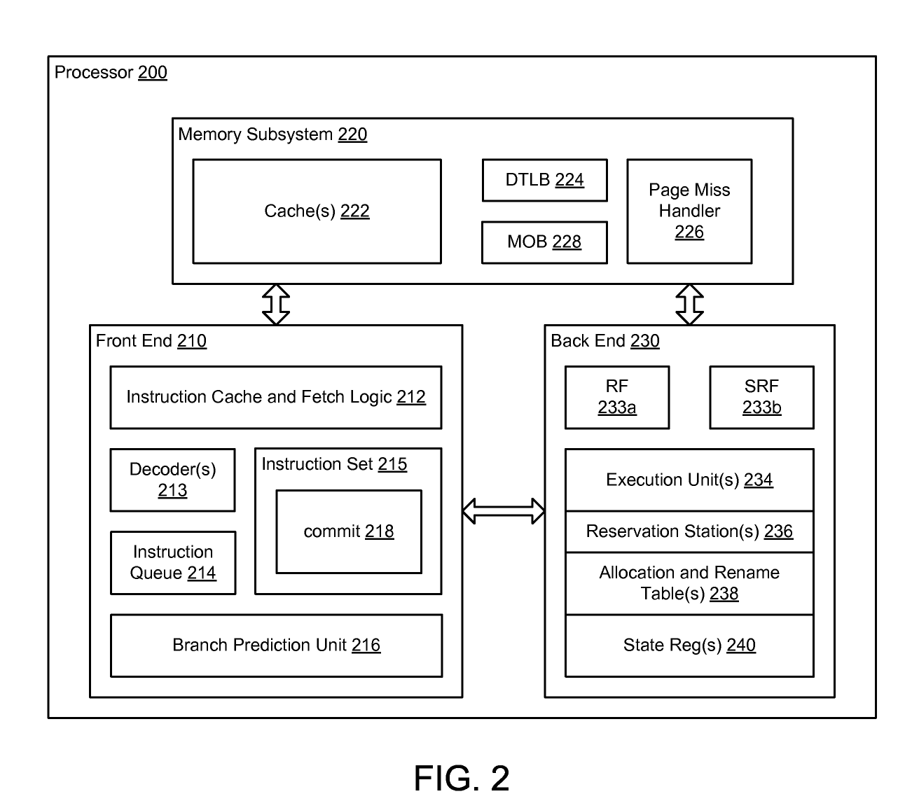

FIG. 2 illustrates elements of a processor 200 for processing a commit instruction according to an embodiment. Processor 200 may operate in a computer platform having some or all of the features of computer platform 100—e.g. where processor 200 includes some or all of the functionality of processor 109. Processor 200 may be one of any of a variety of processor types, such as a single core processor or a multi-core processor including multiple homogeneous or heterogeneous cores.

In an embodiment, processor 200 includes three general groups of functional components, namely a front end (FE) 210, a memory subsystem (MS) 220, and a (BE) back end 230. FE 210 may, for example, include logic in support certain conventional instruction decode functionality—e.g. for supporting in-order execution or out-of-order execution. Additionally or alternatively, BE 230 may include some conventional functionality—e.g. of reservation stations, retirement buffers, execution units, a register file and/or other architectural elements—that regulate the flow of data execution. In certain embodiments providing functionality such as that of an Intel Architecture™ (IA32) processor, FE 210 and BE 230 may be further distinguished by the fact that FE 210 primarily deals with macro-operations, which are assembly instructions, while BE 230 deals with decoded micro-operations (pops), which are simpler instructions that have a many-to-one mapping with macro-ops.

Accordingly, as shown in FIG. 2, an illustrative front end 210 may include, for example, an instruction cache and fetch logic 212 to obtain instruction information from lower cache levels (e.g., cache 222 of memory subsystem 220)—e.g. to temporarily store instructions that are expected to be used soon or multiple times. Coupled to instruction cache 212 may be one or more decoders 213 to decode instructions and an instruction queue 214 to store pending instructions in connection with an instruction set 215. Although certain embodiments are not limited in this regard, a branch prediction unit (BPU) 216 may additionally or alternatively be present in FE 210 to predict a branch to be taken during program execution such that the instructions associated with the predicted branch may be obtained ahead of time.

In an embodiment, instruction set 215 defines or otherwise supports a commit instruction type 218. Decoder 213 may include or otherwise have access to logic for decoding an instruction which is of the commit instruction type 218. In an embodiment, decoding such a commit instruction may include performing one or more operations to determine whether the commit instruction is for contingent performance of a commit action. In an alternate embodiment, such performing of a contingency test may be part of an execution by backend 230 of the already decoded commit instruction.

As shown, front end 210 may communicate with memory subsystem 220. Subsystem 220 may include one or more caches 222—e.g. including level 1 (L1) and level 2 (L2) caches, where the L1 cache may be a data cache and the L2 cache a unified cache including both data and instructions. To aid with address translations, subsystem 220 may further include one or more conventional mechanisms such as a data translation lookaside buffer (DTLB) 224 and, in certain embodiments a page miss handler (PMH) 226—e.g. to aid in accessing requested information from other levels of a memory hierarchy when a miss occurs to DTLB 224. Still further, memory subsystem may include a memory order buffer (MOB) 228, which may include store and load buffers to store entries associated with pending data transfer instructions, e.g., store and load instructions. However, certain embodiments may not be limited with regard to the particular components of memory subsystem 220 for aiding access to cache 222.

Further coupled to both front end 210 and memory subsystem 220 is back end 230, which may be used, for example, to execute instructions decoded by front end 210. As shown in FIG. 2, an illustrative back end 230 may include register file 233a, shadow register file 233b and one or more execution units 234, which may include one or more integer units, floating point units, vector units and/or the like. Still further, back end 230 may include reservation stations 236, which may be used to provide instructions and operands to execution units 234. In turn, entries are provided to reservation stations 236 by allocation and rename tables 238, which may receive incoming instructions from front end 210 and allocate them to the various resources, including execution units 234 and register files 232, along with performing any renaming of some limited number of logical registers to the larger numbers of physical registers present in register file 233a and/or shadow register 233b.

Back end 230 may include one or more components for execution of a decoded commit instruction—e.g. including performance of a commit action by processor 200. Certain operations comprising the commit action itself may be according to one or more conventional techniques for committing processor state. The commit may result in register file 233a being copied into shadow register file 233b, and speculative bits corresponding to one or more lines in cache 222 being cleared. In an embodiment, a commit instruction may not be retired until all these actions are complete.

In the course of some subsequent speculative execution of code by execution units 234, speculative state information may be written to register file 233a and/or to memory subsystem 220 for describing one or more speculative cache line states of cache 222. On executing a rollback action, speculative memory requests may be dropped, shadow register file 233b may be copied back to register file 233a and all cache lines in cache 22 with speculative bits set may be set to invalid. In an embodiment, a rollback instruction may not be retired until all these actions are complete.

Where a commit instruction is determined to be for conditional performance of a commit action, the one or more execution units 234 may evaluate state information—e.g. represented by an illustrative set of one or more state registers 240 of processor. The one or more state registers 240 may, for example, variously store information representing current processor state which is regularly updated during various instruction execution and/or other ongoing operations of processor 200. By way of illustration and not limitation, one or more state registers 240 may store a count of a number of instructions which have been executed since a particular event—e.g. since a most recent commit action, since a most recent rollback and/or the like. Alternatively or in addition, one or more state registers 240 may store a count of a number of instructions which are currently pending for execution, a count of a number of pending memory requests which are yet to be globally observed, information identifying whether any interrupts are currently pending, or any of a variety of additional or alternative aspects of processor state.

In an embodiment, processor 200 may use other information—e.g. stored in state registers 240 and/or elsewhere—for evaluating processor state. By way of illustration and not limitation, processor 200 may access information specifying one or more threshold values—e.g. one or more of a threshold number of instructions which have been executed since a particular event, a threshold number of instructions which are currently pending for execution, a threshold number of currently pending interrupts and/or the like.

Where an evaluation of some condition or conditions for a contingent commit command identifies that one or more conditions have not been met, the commit action indicated by the commit instruction may be avoided altogether (“skipped”). A skipped commit action may act as a NOP instruction in the pipeline of processor 200. As such, a commit instruction representing a contingent command may, under various conditions of processor state, not perform any of the aforementioned operations to implement a commit action. Instead, the commit instruction may be retired in response to the one or more conditions not being met.

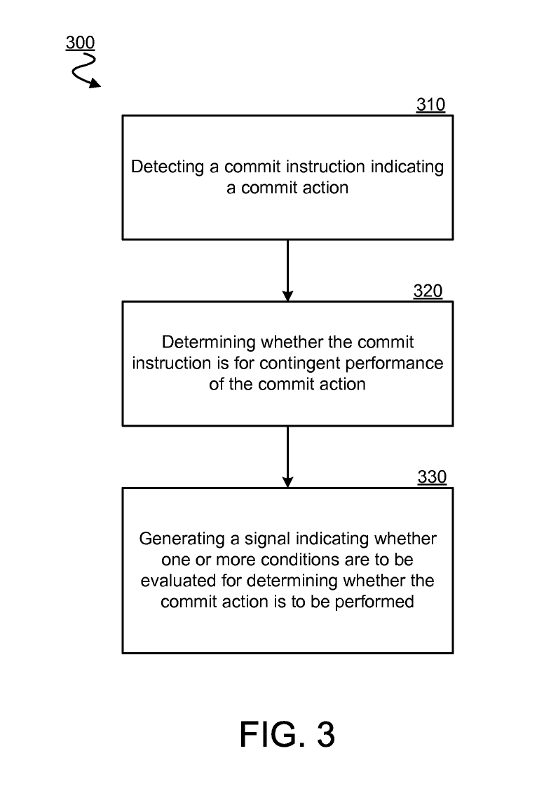

FIG. 3 illustrates elements of a method 300 for processing a commit instruction according to an embodiment. Method 300 may, for example, be performed by a processor including some or all of the features of processor 200.

In an embodiment, method 300 includes, at 310, detecting a commit instruction indicating a commit action. For example, the commit instruction may be sent to, retrieved or otherwise accessed by the processor in the course of executing some code instruction sequence. Method 300 may further include, at 320, determining—e.g. in response to the detecting of the commit instruction—whether the commit instruction is for contingent performance of the commit action. Such determining may, in an embodiment, be based on a value of a command contingency parameter—e.g. a value in a hint bit parameter—of the command instruction. This may be the case, for example, where the commit instruction is of a commit instruction type which is generic to both categorical performance of commit actions commands and contingent performance of commit actions.

Alternatively or in addition, other information may be used as a basis for a contingency test for the commit instruction. For example, the commit instruction detected at 310 may include a command field which stores information specifying an instruction type of the commit instruction—e.g. where the instruction type is defined or otherwise supported by an instruction set of the processor. Determining whether the commit instruction is for contingent performance of the commit action may be based on such a command field indicating a commit instruction type which is specific to contingent performance of commit actions—e.g. as distinct from categorical performance of commit actions.

In processing an instruction of a generic commit instruction type, a processor may be configured to implement a presumption that an instruction of the commit instruction type is to be considered as representing a contingent commit command, in the absence of that instruction including contingency parameter information specifying that the instruction represents a categorical commit command. In an alternate embodiment, a processor may be configured to implement another presumption that an instruction of the commit instruction type is instead to be considered as representing a categorical commit command, in the absence of that instruction including contingency parameter information specifying that the instruction represents a contingent commit command.

Based on the determining of whether the commit instruction is for contingent performance of the commit action, method 300 may include, at 330, generating a signal indicating whether one or more conditions are to be evaluated for determining whether the commit action is to be performed. For example, such a signal may be exchanged from decoder logic of a processor's front end to determine operations of an execution unit of the processor's back end. In an alternate embodiment, such a signal may be exchanged between functional components within the one or more execution units of a processor's back end.

In one embodiment, the determining at 320 may be performed by a decoder of a processor. In an alternate embodiment, the determining may be performed by an execution unit of the processor after decoding has been completed. Accordingly, the determining at 320 and the signal generating at 330 may be performed by a set of processor circuit logic which includes a decoder and an execution unit, although the respective contributions of decoder and execution unit to such operations may vary with different embodiments.

One or more additional operations may follow from the operations shown for method 300, according to different embodiments. For example, where the commit instruction is determined to be for contingent performance of the commit action, an evaluation of the one or more conditions may be performed to identify whether the commit action is to be performed. In an embodiment, the one or more conditions to be evaluated include processor state which is independent of the commit instruction being received by the processor.

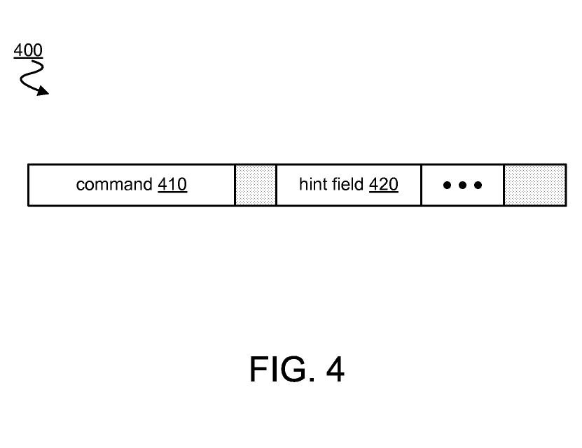

FIG. 4 illustrates elements of a commit instruction 400 to be processed according to an embodiment. Commit instruction 400 may be processed by a processor having some or all of the features of processor 200, for example. In an embodiment, processing of commit instruction 400 may be according to method 300.

Commit instruction 400 may include information indicating a commit action—e.g. where the information indicates the possibility that such a commit action is to be performed by execution of the commit instruction. For example, commit instruction 400 may include information indicating whether commit instruction 400 is for conditional performance of such a commit action.

For example, commit instruction 400 may include a command field 410 to store information specifying a particular commit instruction type. Information in command field 410 may, for example, identify an instruction type which is specific to a particular one of contingent commit commands and categorical commit commands. Alternatively, information in command field 410 may identify a commit instruction type which is generic at least insofar as the instruction type is for representing either contingent commit commands or categorical commit commands.

Commit instruction 400 may additionally or alternatively include one or more parameters to indicate whether commit instruction 400 is for a conditional performance of a commit action. For example, commit instruction 400 may include a hint field 420 to store a bit value, a flag value and/or other such information to represent a contingency state—e.g. either conditional or categorical—of the command represented by the commit instruction.

In an embodiment, commit instruction 420 may include one or more additional parameters, or other information, in aid of an evaluation of whether execution of commit instruction is to result in a commit action being performed. By way of illustration and not limitation, commit instruction 400 may include information (not shown) identifying one or more conditions which are to be evaluated for determining whether a commit action is to be performed. Alternatively or in addition, commit instruction 400 may include information (not shown) identifying one or more threshold levels to be used in an evaluation of one or more conditions to performing a commit action.

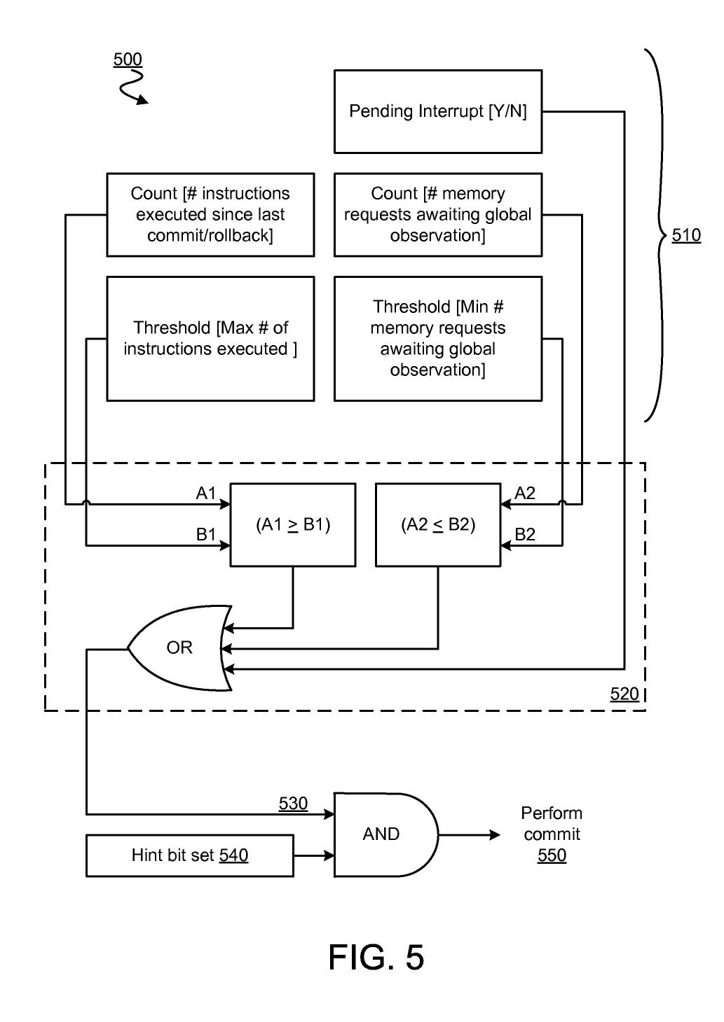

FIG. 5 is a functional representation of a circuit 500 configured to evaluate one or more conditions to determine, according to an embodiment, whether to a commit action indicated in a commit instruction is to be performed. Circuit 500 may, for example, reside in circuit logic of a processor including some or all of the features of processor 200, although certain embodiments are not limited in this regard. For example, circuit 500 may be included in, or otherwise available to, one of the one or more execution units 234 which executes a commit instruction.

Operation of circuit 500 may be in response to a determination that a given commit instruction is for contingent execution of a commit action. Such execution may, for example, be contingent at least insofar as it is subject to a result of the evaluation performed by circuit 500. In an illustrative scenario shown in FIG. 5, circuit 500 is to receive a set of one or more inputs 510 for evaluating the one or more conditions for performing (or alternatively, for not performing) a commit action which is indicated in a commit instruction.

By way of illustration and not limitation, the processor may provide one or more configuration registers in which an optimizer, for example, may store information specifying a maximum number of executed instructions between two commit points and/or between a rollback and a commit. Although it may be advantageous to skip several consecutive skip commit instructions, at some point it is more efficient to perform a commit than to skip another commit opportunity. This may be so when, for example, current processor state means a rollback would require undoing too much work, potentially resulting in power and performance issues. In an embodiment, circuit 500 may include or otherwise have access to a counter register that counts executed instructions. Such a counter may be regularly compared to some specified threshold and reset to zero whenever a commit or a rollback action is executed. The outcome of this comparison may force a commit when a commit instruction is executed—e.g. when a commit instruction indicates a skippable commit action, but the processor has executed enough instructions since the last commit point. A threshold value of zero may force all skippable commit instructions to commit. In an embodiment, a threshold value may be modified by the optimizer or other agent—e.g. in order to variously adapt the behavior of the processor during operation to particular situations. Heuristics used to determine and/or tune such a threshold value may vary according to application-specific implementation details, and are not limiting on certain embodiments.

Additionally or alternatively, circuit 500 may receive an input—e.g. based on signals from the memory subsystem—identifying a current count of a number of memory requests which have yet to be globally observed. For instance, if it is assumed (for simplicity's sake) that each missed memory request to access a L1 data cache takes N cycles to be globally observed, then an illustrative instruction sequence of COMMIT, MEMORY, COMMIT, MEMORY and COMMIT may stall an execution pipeline by 2N cycles (N cycles at the second commit point and N cycles at third commit point). On the other hand, a sequence of COMMIT, MEMORY, COMMIT SKIPPED, MEMORY and COMMIT may stall the pipeline by only N cycles (at the third commit point) since both memory requests awaiting global observation will be overlapped.

Therefore, the processor may include a counter register that counts the amount of memory requests that arc awaiting global observation. This counter may be compared to another configuration register by which the optimizer may specify a threshold minimum number of memory requests awaiting global observation. A commit may be forced if there are fewer pending memory requests awaiting global observation than those specified by the threshold register. For example, a value of zero to such a register may cause skippable commit actions to be skipped as long as there are memory requests pending for global observation (and if all other conditions hold).

Additionally or alternatively, a processor may use an amount of pending interrupts as an additional or alternative input to decide whether to perform or skip a skippable commit action. In particular, a skippable commit action may be performed if there are pending interrupts since the last commit or rollback points. Interrupts are typically blocked while executing code between commit points, where the code execution between two commits is speculative, and a rollback to a previous consistent state may be required if an interrupt is raised in the middle. However, since delaying interrupts for too long poses a performance risk, a skippable commit action may be forced if interrupts are pending whenever a contingent commit command is indicated by a commit instruction.

Features of an illustrative operation of circuit 500 according to one embodiment are discussed below in view of the above-described considerations. By way of illustration and not limitation, a set of one or more inputs 510 for circuit 500 may include an input identifying a current count of a number of instructions which have been executed since a most recent commit action or rollback operation. Alternatively or in addition, the one or more inputs 510 may include an input identifying a current number of memory access requests awaiting global observation and/or an input identifying whether any interrupts are currently pending.

In one embodiment, one or more threshold values 510 may further include various threshold values—e.g. including a maximum threshold number of instructions which have been executed and/or a minimum threshold number of memory requests awaiting global observation. The particular inputs 510 shown in FIG. 5 arc illustrative of merely one scenario according to one embodiment. However, circuit 500 may receive any of a variety of one or more additional or alternative inputs, according to different embodiments.

Evaluation of one or more conditions for a contingent commit command may include the one or more inputs 510 being variously provided each to respective ones of more logic elements 520 of circuit 500. By way of illustration and not limitation, logic elements 520 may include circuitry to determine whether some maximum threshold number of has been exceeded by the input number of instructions executed since a most recent commit action or rollback operation. Alternatively or in addition, logic elements 520 may determine whether the input current number of memory requests awaiting global observation is below some minimum threshold number. Alternatively or in addition, logic elements 520 may determine whether any interrupts are currently pending.

In the illustrative scenario for circuit 500, the respective outcomes of the above-described determinations may further be operated on by logic elements 520—e.g. where the respective outcomes are OR'ed with one another. However, the particular evaluation operations of logic elements 520 are illustrative of merely one scenario according to one embodiment. Circuit 500 may perform any of a variety of combinations of one or more additional or alternative evaluation operations, according to different embodiments.

Based on the logic operations performed on the set of one or more inputs 510, logic elements 520 may generate a signal 530 indicating whether current processor state meets the one of more conditions for the contingent performance of a commit action. Signal 530 may identify, or otherwise provide a basis for identifying, that a commit action is to be performed. For example, signal 530 may be logically ANDed with an indication 540 that a hint bit of the commit instruction is set to indicate a contingent commit command. Based on signal 530 and indication 540, an output 550 may be generated which results in performance of the commit action indicated in the commit instruction.

Techniques and architectures for operating a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A method at a processor, the method comprising:
detecting a commit instruction indicating a commit action;
in response to the detecting, determining whether the commit instruction is for contingent performance of the commit action; and
based on the determining, generating a signal indicating whether one or more conditions are to be evaluated for determining whether the commit action is to be performed.

2. The method of claim 1, wherein determining whether the commit instruction is for contingent performance of the commit action is based on a value of a command contingency parameter of the command instruction.

3. The method of claim 1, wherein determining whether the commit instruction is for contingent performance of the commit action is based on a command field of the commit instruction indicating a commit instruction type which is specific to contingent performance of commit actions.

4. The method of claim 1, wherein the commit instruction includes a command field including information indicating an instruction type of the commit instruction, wherein determining whether the commit instruction is for contingent performance of the commit action includes identifying whether the commit instruction further includes a command contingency parameter.

5. The method of claim 1, wherein the commit instruction is determined to be for contingent performance of the commit action, the method further comprising:
evaluating the one or more conditions to identify whether the commit action is to be performed, wherein the one or more conditions includes processor state which is independent of the commit instruction being received by the processor.

6. The method of claim 5, wherein evaluating the one or more conditions is based on a count of a number of instructions executed since an event preceding the detecting the commit instruction.

7. The method of claim 6, wherein the event includes one or a commit action and a rollback action.

8. The method of claim 5, wherein evaluating the one or more conditions is based on a count of a number of memory requests awaiting global observation in the processor.

9. The method of claim 5, wherein evaluating the one or more conditions is based on a number of pending interrupts.

10. The method of claim 1, wherein the commit instruction of a commit instruction type which is generic to both categorical performance of commit actions commands and contingent performance of commit actions.

11. The method of claim 10, wherein, according to configuration information of the processor, an instruction of the commit instruction type is presumed to represent a contingent commit command, in the absence of any command contingency parameter of the instruction specifying that the instruction represents a categorical commit command.

12. The method of claim 10, wherein, according to configuration information of the processor, an instruction of the commit instruction type is presumed to represent a categorical commit command, in the absence of any command contingency parameter of the instruction specifying that the instruction represents a contingent commit command.

13. A processor comprising:
an instruction set;
a decoder including circuit logic to detect a commit instruction indicating a commit action and to decode the commit instruction according to the instruction set; and
an execution unit to execute the decoded commit instruction;
wherein the decoder and the execution unit to determine whether the commit instruction is for contingent performance of the commit action, and wherein the decoder and the execution unit to generate, based on the determining, a signal indicating whether one or more conditions are to be evaluated for determining whether the commit action is to be performed.

14. The processor of claim 13, wherein the decoder and the execution unit to determine whether the commit instruction is for contingent performance of the commit action is based on a value of a command contingency parameter of the command instruction.

15. The processor of claim 13, wherein the decoder and the execution unit to determine whether the commit instruction is for contingent performance of the commit action is based on a command field of the commit instruction indicating a commit instruction type which is specific to contingent performance of commit actions.

16. The processor of claim 13, wherein the commit instruction includes a command field including information indicating an instruction type of the commit instruction, wherein the decoder and the execution unit to determine whether the commit instruction is for contingent performance of the commit action includes identifying whether the commit instruction further includes a command contingency parameter.

17. The processor of claim 13, wherein the decoder and the execution unit further to evaluate the one or more conditions to identify whether the commit action is to be performed, wherein the one or more conditions includes processor state which is independent of the commit instruction being received by the processor.

18. The method of claim 17, wherein the evaluating the one or more conditions is based on a count of a number of instructions executed since an event preceding the detecting the commit instruction.

19. The method of claim 18, wherein the event includes one or a commit action and a rollback action.

20. The method of claim 17, wherein the evaluating the one or more conditions is based on a count of a number of memory requests awaiting global observation in the processor.

21. The method of claim 17, wherein the evaluating the one or more conditions is based on a number of pending interrupts.

22. The processor of claim 13, wherein the commit instruction of a commit instruction type which is generic to both categorical performance of commit actions commands and contingent performance of commit actions.

23. The processor of claim 22, wherein, according to configuration information of the processor, an instruction of the commit instruction type is presumed to represent a contingent commit command, in the absence of any command contingency parameter of the instruction specifying that the instruction represents a categorical commit command.

24. The processor of claim 22, wherein, according to configuration information of the processor, an instruction of the commit instruction type is presumed to represent a categorical commit command, in the absence of any command contingency parameter of the instruction specifying that the instruction represents a contingent commit command.

25. A computer platform comprising:
a memory;
a processor coupled to the memory, the processor including
an instruction set;
a decoder coupled including circuit logic to detect a commit instruction indicating a commit action and to decode the commit instruction according to the instruction set; and
an execution unit to execute the decoded commit instruction;
wherein the decoder and the execution unit to determine whether the commit instruction is for contingent performance of the commit action, and wherein the decoder and the execution unit to generate, based on the determining, a signal indicating whether one or more conditions arc to be evaluated for determining whether the commit action is to be performed; and
a network interface to couple the computer platform to a network.

26. The computer platform of claim 25, wherein the decoder and the execution unit to determine whether the commit instruction is for contingent performance of the commit action is based on a value of a command contingency parameter of the command instruction.

27. The computer platform of claim 25, wherein the decoder and the execution unit to determine whether the commit instruction is for contingent performance of the commit action is based on a command field of the commit instruction indicating a commit instruction type which is specific to contingent performance of commit actions.

28. The computer platform of claim 25, wherein the commit instruction includes a command field including information indicating an instruction type of the commit instruction, wherein the decoder and the execution unit to determine whether the commit instruction is for contingent performance of the commit action includes identifying whether the commit instruction further includes a command contingency parameter.

29. The computer platform of claim 25, wherein the decoder and the execution unit further to evaluate the one or more conditions to identify whether the commit action is to be performed, wherein the one or more conditions includes processor state which is independent of the commit instruction being received by the processor.

30. The method of claim 29, wherein the evaluating the one or more conditions is based on a count of a number of instructions executed since an event preceding the detecting the commit instruction.
